(19) United States
(12) Patent Application Publication
(10) Pub. No.: US 2026/0255311 A1
(43) Pub. Date: Aug. 27, 2026

(54) COVERAGE ANALYSIS PREDICTION SYSTEM FOR MOBILE NETWORKS

(71) Applicant: TURKCELL TEKNOLOJI ARASTIRMA VE GELISTIRME ANONIM SIRKETI, Istanbul (TR)

(72) Inventors: Semih AKTAS, Istanbul (TR); Gokhan KALEM, Istanbul (TR)

(73) Assignee: TURKCELL TEKNOLOJI ARASTIRMA VE GELISTIRME ANONIM SIRKETI, Istanbul (TR)

(21) Appl. No.: 19/491,198

(22) PCT Filed: Dec. 28, 2023
(86) PCT No.: PCT/TR2023/051804

§ 371 Date: Dec. 8, 2025

(30) Foreign Application Priority Data
Sep. 26, 2023 (TR) 2023/012022

(51) Int. Cl. H04W 64/00; H04B 17/318; H04W 24/10

(52) U.S. Cl. CPC H04W 64/00; H04B 17/318; H04W 24/10

(57) ABSTRACT

The present invention relates to a system for predicting the coverage area of a mobile network via analysis of the data obtained from the users served by base stations (A), by using big data processing techniques with a trained model.

### TECHNICAL FIELD

The present invention relates to a system for predicting the coverage area of a mobile network via analysis of the data obtained from the users served by base stations, by using big data processing techniques with a trained model.

### BACKGROUND OF THE INVENTION

In the state of the art, there are numerous applications used to simulate mobile network coverage at the planning stage. These applications provide a modeling directly according to the specifications of a base station and act independently of user experience. On a global scale, almost all operators benefit from these applications when planning coverage and capacity in their mobile networks and application manufacturers dominate the market. However, using no user data and experiences in these applications does not provide sufficiently accurate measurements and analysis.

Therefore, considering the studies and the shortcomings included in the current technique, it is understood that there is need for a system for predicting the coverage area of a mobile network via analysis of the data obtained from the users served by base stations, by using big data processing techniques with a trained model.

The Chinese patent document no. CN110731096A, an application included in the state of the art and accessed as a result of research, discloses a computer-implemented method for predicting received signal strength in a telecommunication network. The method included in the said invention includes receiving, by one or more processors that execute a convolutional neural network, geographic data representing geographic information of a geographic area and antenna and transmit power information of a base station in the geographic area; inputting the geographic data and the antenna and transmit power information into the convolutional neural network; predicting received signal strength by using the convolutional neural network that includes a number of convolution layers based on the received geographic data and the antenna and transmit power information; and outputting the predicted received signal strength. Herein, the received signal strength represents signal strength of wireless signals received at different locations in the geographic area.

### SUMMARY OF THE INVENTION

An objective of the present invention is to realize a system for predicting the coverage area of a mobile network via analysis of the data obtained from the users served by base stations, by using big data processing techniques with a trained model.

Another objective of the present invention is to realize a system for processing the data generated by mobile network users by using big data processing techniques, and positioning the measurement reports created by the users in latitude and longitude.

### DETAILED DESCRIPTION OF THE INVENTION

“A Coverage Analysis Prediction System for Mobile Networks” realized to fulfil the objective of the present invention is shown in the figure attached, in which:

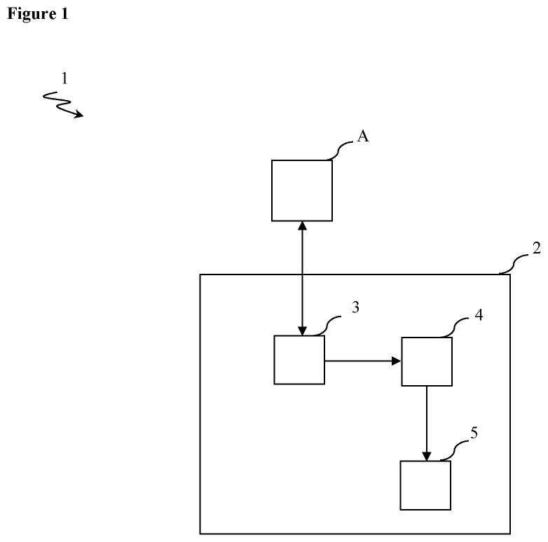

FIG. 1 is a schematic view of the inventive system.

The components illustrated in the figure are individually numbered, where the numbers refer to the following:
1. System
2. Electronic device
3. Data collection application
4. Positioning application
5. Prediction application

### A. Base Station

The inventive system (1) for predicting the coverage area of a mobile network via analysis of the data obtained from the users served by base stations, by using big data processing techniques with a trained model; comprises
at least one electronic device (2) which is configured to realize data exchange by using any remote communication protocol and to run at least one application thereon;
at least one data collection application (3) which is run on the electronic device (2) and configured to receive at least the property data of the base station (A) and the measurement report data of the user equipment from the base station (A) and to keep record of them;
at least one positioning application (4) which is run on the electronic device (2) and configured to receive, process at least the data obtained by the data collection application (3); to determine the location of the point where the measurement reports created from the user equipment are sent to and to keep record of the measurement report created from each user equipment as a result of positioning, together with the latitude and longitude information;
at least one prediction application (5) which is run on the electronic device (2) and configured to group at least the results of positioning created by the positioning application (4), on the basis of the base station (A); to process, analyse the data about the base station (A) grouped and the data generated by the user equipment connected to the related base station (A); to ensure that the coverage area of the base station (A) is calculated and reported based on real user experience.

The electronic device (2) included in the inventive system (1) is a device such as smartphone, tablet computer, desktop computer or portable computer configured to run at least one data collection application (3), positioning application (4) and prediction application (5) thereon. The electronic device (2) The said electronic device (2) has speakers for providing audio output, an input unit such as a key or touch screen, and at least one camera configured to take picture.

The data collection application (3) included in the inventive system (1) is a software run on the electronic device (2). The said data collection application (3) is configured to establish communication and exchange data with the base station (A) over the electronic device (2). The data collection application (3) is configured to receive the measurement reports-that are transmitted by the user equipment to the base stations (A), where they are connected to, at certain periods over the communication established with the base station (A) and that comprise information about the network experience it performs from its position such as the signal strength the equipment receives from the base station (A) where it is connected to, the signal strengths of the other stations (A) around it, the time-stamp, the channel qualities-and the property data such as antenna models for the base station (A), directions of sector antenna, gains of antenna, heights of antenna, locations of station, modulation information, bendings of electronic and mechanical antenna about the base station (A), over the base station (A) and to keep record of them.

The positioning application (4) included in the inventive system (1) is a software run on the electronic device (2). The said positioning application (4) is configured to establish communication with the data collection application (3); to receive the measurement report data generated by the user equipment and then to process them; and to determine the location of the point where the report is sent from. In one preferred embodiment of the invention, the positioning application (4) is configured to perform positioning by using the signal strength information. The said positioning application (4) is configured to detect the latitude and longitude information of the user equipment by calculating the distance from the base station (A) by using signal propagation models, according to the incoming signal strength when a signal whose output power is known is received by the user equipment. The positioning application (4) is configured to determine the distance of the user equipment that receives signal from a plurality of different base stations (A) and to detect the latitude and longitude information of the user equipment at the point where the determined distance data coincide, when performing positioning by means of signal strength information. In another preferred embodiment of the invention, the positioning application (4) is configured to positon the user equipment on the basis of the transfer times of measurement reports (data transfer time). The said positioning application (4) is configured to calculate the distance by multiplying the signal speed by the transfer time. The positioning application (4) is configured to determine the distance of the user equipment that receives signal from a plurality of different base stations (A) and to detect the latitude and longitude information of the user equipment at the point where the determined distance data coincide, when performing positioning with the transfer time information. In another preferred embodiment of the invention, the positioning application (4) is configured to perform positioning by providing the results obtained from the conventional positioning method as a data source, to the Long-Short Term Memory (LSTM) machine learning algorithm as an input in addition to all data received from the data collection application (3). The positioning application (4) is configured to keep record of each measurement report generated from each user as a result of positioning, together with the latitude and longitude information.

The prediction application (5) included in the inventive system (1) is a software run on the electronic device (2). The said prediction application (5) is configured to predict the coverage area of the base station (A) in accordance with the positioned user data obtained by the positioning application (4). The prediction application (5) is configured to receive the positioning results obtained by the positioning application (4) and then to group the said results on the basis of the base station (A) and to obtain the data available to calculate the coverage area separately for each station (A). The prediction application (5) is configured to use the data of the base station (A)-whose coverage area will be predicted and which is made ready to be used for prediction of coverage area-upon the transactions of data positioning generated by the user equipment connected to a station are carried out and grouped on the basis of the base station (A) and to obtain the unique service quality at every point where the base station (A) provides service, from the data set and then to analyse it by means of the big data generated by the users who are connected to the base station (A) in order to predict the coverage area. The prediction application (5) is configured to perform data cleaning in order to detect the area created by the distributed points on the data set, and to detect the outlier data by using outlier detection algorithms. The prediction application (5) is configured to delete the measurement reports apart from the acceptable level by determining the acceptable service quality as a parameter, and to tag the remaining points as the ones where the base station (A) actively serves. The prediction application (5) is configured to calculate the area covering all points by using Convex Hull approach in order to calculate the service area from the points where the station (A) effectively serves, and to determine the calculated area as the effective service area (coverage area) and then to keep record of it.

### INDUSTRIAL APPLICABILITY OF THE INVENTION

With the inventive system (1), it is possible to predict the coverage area of a mobile network via analysis of the data obtained from the users served by base stations (A), by using big data processing techniques with a trained model.

Within these basic concepts; it is possible to develop various embodiments of the inventive “Coverage Analysis Prediction (1) for Mobile Networks”; the invention cannot be limited to examples disclosed herein and it is essentially according to claims.

1. A system (1) for predicting the coverage area of a mobile network via analysis of the data obtained from the users served by base stations, by using big data processing techniques with a trained model; comprising
at least one electronic device (2) which is configured to realize data exchange by using any remote communication protocol and to run at least one application thereon;
at least one data collection application (3) which is run on the electronic device (2) and configured to receive at least the property data of the base station (A) and the measurement report data of the user equipment from the base station (A) and to keep record of them;
and characterized by
at least one positioning application (4) which is run on the electronic device (2) and configured to receive, process at least the data obtained by the data collection application (3); to determine the location of the point where the measurement reports created from the user equipment are sent to and to keep record of the measurement report created from each user equipment as a result of positioning, together with the latitude and longitude information;
at least one prediction application (5) which is run on the electronic device (2) and configured to group at least the results of positioning created by the positioning application (4), on the basis of the base station (A); to process, analyse the data about the base station (A) grouped and the data generated by the user equipment connected to the related base station (A); to ensure that the coverage area of the base station (A) is calculated and reported based on real user experience.

2. A system (1) according to claim 1; characterized by the electronic device (2) which is a device such as smartphone, tablet computer, desktop computer or portable computer configured to run at least one data collection application (3), positioning application (4) and prediction application (5) thereon.

3. A system (1) according to claim 1; characterized by the electronic device (2) which has speakers for providing audio output, an input unit such as a key or touch screen, and at least one camera configured to take picture.

4. A system (1) according to claim 1, characterized by the data collection application (3) which is a software run on the electronic device (2).

5. A system (1) according to claim 1, characterized by the data collection application (3) which is configured to establish communication and exchange data with the base station (A) over the electronic device (2).

6. A system (1) according to claim 1, characterized by the data collection application (3) which is configured to receive the measurement reports-that are transmitted by the user equipment to the base stations (A), where they are connected to, at certain periods over the communication established with the base station (A) and that comprise information about the network experience it performs from its position such as the signal strength the equipment receives from the base station (A) where it is connected to, the signal strengths of the other stations (A) around it, the time-stamp, the channel qualities-and the property data such as antenna models for the base station (A), directions of sector antenna, gains of antenna, heights of antenna, locations of station, modulation information, bendings of electronic and mechanical antenna about the base station (A), over the base station (A) and to keep record of them.

7. A system (1) according to claim 1, characterized by the positioning application (4) which is a software run on the electronic device (2).

8. A system (1) according to claim 1, characterized by the positioning application (4) which is configured to establish communication with the data collection application (3); to receive the measurement report data generated by the user equipment and then to process them; and to determine the location of the point where the report is sent from.

9. A system (1) according to claim 1, characterized by the positioning application (4) which is configured to perform positioning by using the signal strength information.

10. A system (1) according to claim 1, characterized by the positioning application (4) which is configured to detect the latitude and longitude information of the user equipment by calculating the distance from the base station (A) by using signal propagation models, according to the incoming signal strength when a signal whose output power is known is received by the user equipment.

11. A system (1) according to claim 1, characterized by the positioning application (4) which is configured to determine the distance of the user equipment that receives signal from a plurality of different base stations (A) and to detect the latitude and longitude information of the user equipment at the point where the determined distance data coincide, when performing positioning by means of signal strength information.

12. A system (1) according to claim 1, characterized by the positioning application (4) which is configured to positon the user equipment on the basis of the transfer times of measurement reports.

13. A system (1) according to claim 1, characterized by the positioning application (4) which is configured to calculate the distance by multiplying the signal speed by the transfer time.

14. A system (1) according to claim 1, characterized by the positioning application (4) which is configured to determine the distance of the user equipment that receives signal from a plurality of different base stations (A) and to detect the latitude and longitude information of the user equipment at the point where the determined distance data coincide, when performing positioning with the transfer time information.

15. A system (1) according to claim 1, characterized by the positioning application (4) which is configured to perform positioning by providing the results obtained from the conventional positioning method as a data source, to the Long-Short Term Memory machine learning algorithm as an input in addition to all data received from the data collection application (3).

16. A system (1) according to claim 1, characterized by the positioning application (4) which is configured to keep record of each measurement report generated from each user as a result of positioning, together with the latitude and longitude information.

17. A system (1) according to claim 1, characterized by the prediction application (5) which is a software run on the electronic device (2).

18. A system (1) according to claim 1, characterized by the prediction application (5) which is configured to predict the coverage area of the base station (A) in accordance with the positioned user data obtained by the positioning application (4).

19. A system (1) according to claim 1, characterized by the prediction application (5) which is configured to receive the positioning results obtained by the positioning application (4) and then to group the said results on the basis of the base station (A) and to obtain the data available to calculate the coverage area separately for each station (A).

20. A system (1) according to claim 1, characterized by the prediction application (5) which is configured to use the data of the base station (A)-whose coverage area will be predicted and which is made ready to be used for prediction of coverage area-upon the transactions of data positioning generated by the user equipment connected to a station are carried out and grouped on the basis of the base station (A) and to obtain the unique service quality at every point where the base station (A) provides service, from the data set and then to analyse it by means of the big data generated by the users who are connected to the base station (A) in order to predict the coverage area.

21. A system (1) according to claim 1, characterized by the prediction application (5) which is configured to perform data cleaning in order to detect the area created by the distributed points on the data set, and to detect the outlier data by using outlier detection algorithms.

22. A system (1) according to claim 1, characterized by the prediction application (5) which is configured to delete the measurement reports apart from the acceptable level by determining the acceptable service quality as a parameter, and to tag the remaining points as the ones where the base station (A) actively serves.

23. A system (1) according to claim 1, characterized by the prediction application (5) which is configured to is configured to calculate the area covering all points by using Convex Hull approach in order to calculate the service area from the points where the station (A) effectively serves, and to determine the calculated area as the effective service area (coverage area) and then to keep record of it.
